(19) United States
(12) Patent Application Publication
(10) Pub. No.: US 2013/0173386 A1
(43) Pub. Date: Jul. 4, 2013

(54) Providing Advertisements in a Digital Reading Platform

(71) Applicants: Vincent Le Chevalier, San Jose, CA (US); Brent S. Tworetzky, Palo Alto, CA (US); Charles F. Geiger, San Jose, CA (US)

(72) Inventors: Vincent Le Chevalier, San Jose, CA (US); Brent S. Tworetzky, Palo Alto, CA (US); Charles F. Geiger, San Jose, CA (US)

(73) Assignee: CHEGG, INC., Santa Clara, CA (US)

(21) Appl. No.: 13/340,417

(22) Filed: Dec. 29, 2011

(51) Int. Cl. G06Q 30/02

(52) U.S. Cl. 705/14.53; 705/14.72

(57) ABSTRACT

Users of an education digital reading platform are provided with advertisements based on their user data. The offers are provided in a course material, such as a textbook, wherein the textbook is identified from a course syllabus. The course material is analyzed to identify ad regions wherein an advertisement may be placed, including embedded ad regions within a course material page and supplement ad regions around a course material page. In addition, predictive data suggesting a user activity in the future may be identified from a course syllabus and opportunistic data providing a current user activity may be used to select advertisements to display to the user. The selected advertisements are mapped to the embedded and supplement ad regions and sent to the user, wherein the selected advertisements are displayed to the user based on the mapping.

### CROSS REFERENCE TO RELATED APPLICATIONS

This application is related to U.S. Utility application Ser. No. 13/253,011, which is incorporated by reference in its entirety.

### BACKGROUND

1. Field of the Invention

This invention relates to providing offers to users using a digital education platform.

2. Description of the Related Art

The education publishing industry faces a number of significant challenges to effectively delivering media and services through an on-line delivery network. These challenges center around five discrete phases:

1. Ingestion: A lack of digital textbook standardization, a plethora of incompatible formats, and a lack of integration and interoperability between publishers makes it difficult to ingest and aggregate a large volume of educational content efficiently and reliably.
2. Publishing: Significant transformation of education content needs to be undertaken to ensure that the content is suited to publish across a variety of client devices that users may use to access the content.
3. Distribution: In an electronic distribution environment, particular attention needs to be given to issues of content protection and rights management, as well as service policies and quality of service, so that content providers are fairly compensated and users of the content perceive the value and reliability of the service.
4. Connected Services: In an educational platform, there exists the potential to deliver a rich user experience that extends beyond electronic access to textbooks. To implement such connected services would require complex business rules and content models that are unavailable in existing education digital publishing services.
5. Advertising: In an educational platform, there exists the potential to provide offers or advertisement to users. However, particular attention needs to be given to where to place the advertisement as well as when to provide certain offers to the users such that they do not undermine an educational experience.

Effectively enabling and managing each of the above five phases has not yet been accomplished by the education publishing industry. Accordingly, this has inhibited the growth of delivering media and services through an on-line delivery network.

### SUMMARY

Embodiments of the invention provide an education digital reading platform that provides aggregation, management, and distribution of digital education content and services. An education digital publishing platform ingests content from a variety of content sources, transforms the content for web-based publication, distributes the content to connected end-user devices, and displays content to a user to deliver a rich user experience wherein the user can interact with the distributed content in ways that are unavailable in a traditional educational platform.

In one embodiment, the education digital reading platform leverages information about a user by providing advertisements to the user. The education digital reading platform identifies ad regions of a document wherein an advertisement may be displayed. Additionally, the education digital reading platform receives opportunistic data, identifying a user's current actions and predictive data, identifying the user's future actions. In one embodiment, the education digital reading platform selects one or more advertisements that the user may be interested in based on the user's opportunistic and predictive data. The identified advertisements are associated with a user's advertising manifest. The advertising manifest selects the one or more ad regions to displays the selected advertisements. The selected advertisements may be displayed at least once in the one or more ad regions when a user is viewing a page associated with the education digital reading platform.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 illustrates a block diagram of a system environment of an education digital reading platform in accordance with an embodiment of the invention.

FIG. 2 illustrates a block diagram for a system for identifying ad regions within a document to be displayed by an education digital reading platform in accordance with an embodiment of the invention.

FIG. 3A is an exemplary illustration of identifying ad regions within a document to be displayed by an education digital reading platform in accordance with an embodiment of the invention.

FIG. 3B is an exemplary illustration of mapping advertisements to ad regions of a document to be displayed by an education digital reading platform in accordance with an embodiment of the invention.

FIG. 3C is an exemplary illustration displaying advertisements mapped to ad regions of a document to be displayed by an education digital reading platform in accordance with an embodiment of the invention.

FIG. 4 illustrates a block diagram of a system for providing advertisements within a document displayed by an education digital reading platform in accordance with an embodiment of the invention.

FIG. 5 illustrates a course syllabus ingested by an education digital reading platform in accordance with an embodiment of the invention.

FIG. 6 illustrates opportunistic data gathered by an education digital reading platform in accordance with an embodiment of the invention.

One skilled in the art will readily recognize from the following discussion that alternative embodiments of the structures and methods illustrated herein may be employed without departing from the principles of the invention described herein.

### DETAILED DESCRIPTION OF THE EMBODIMENTS

### System Overview

The successful and rapid growing adoption of electronic books and web based publishing services is sometimes limited by the available digital content to offer. Publishers have to separately create digital versions of their content besides printed copies to support the new digital offerings. This separate process may introduce increased costs, digital format issues, and production delays that negatively affect the availability of the digital books at content and service providers. Given the average number of pages contained in a book or document, the large and increasing volume of books and documents to process, and the ever evolving and expanding list of consumer devices and software platforms capable of receiving digital content, manual conversion and visual testing in the traditional publishing solutions becomes more and more impractical. Therefore it is highly desirable to have an automated system for converting and testing extremely large volume of contents across permutations of multiple target devices and platforms.

In addition, despite the advance in digital conversion technologies and on-going standardization efforts in the creation and deployment of the electronic books, such as ePub standard and development toolkits, the converted digital content sometimes differs considerably from its original printed equivalent in at least one aspect: page fidelity. Page fidelity refers to the page structure of the original document, including the pagination of the original printed document, the number of columns and arrangement of paragraphs, the placement and appearance of graphics, titles and captions, and the fonts used. Page fidelity is usually not an issue for trade books given their relatively simple text structure and page layout. However, for some other categories of books (e.g., textbooks, education, travel, art, and cooking books), whose images, graphs, tables, maps, proprietary fonts, and multi-columns of text are assembled into complex sets of customized publications, maintaining page fidelity may be highly desired but quite challenging when converting into ePub format or modern markup language web pages.

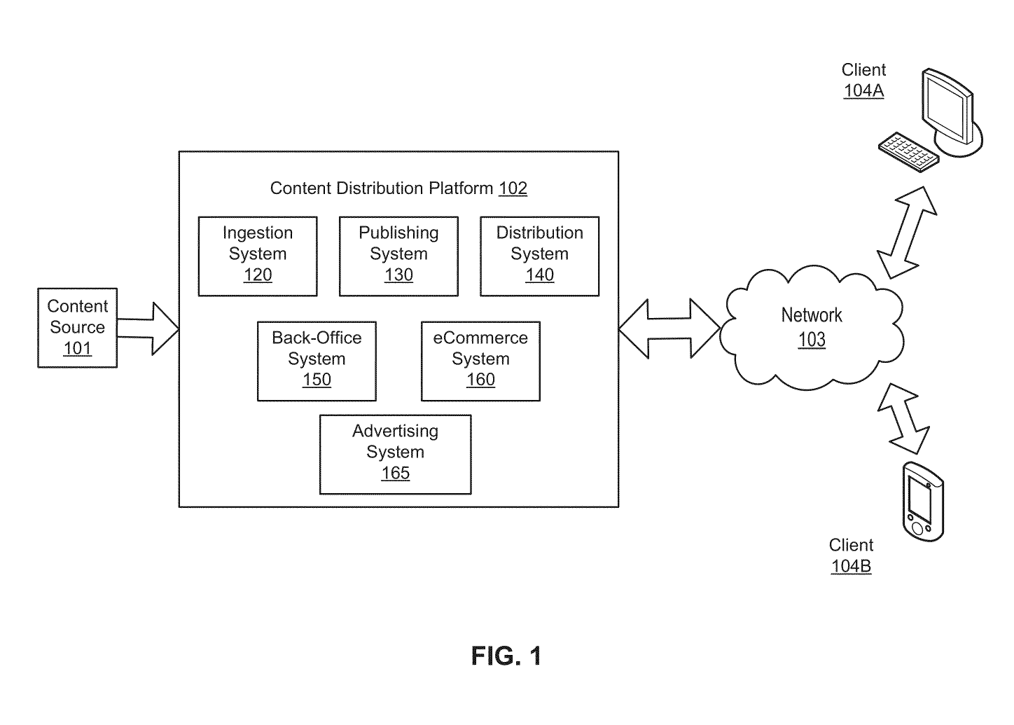

Embodiments of the invention provide a system referred to as a “publishing system.” The system transforms printed documents into, for example, markup language documents (e.g., in HTML5 web format) with enhanced metadata suited for distribution to a wide variety of computing devices. The system aims to preserve page fidelity, regardless of the original format of the source content provided by the content provider, and regardless of the complexity of the layout of the original document. To achieve the page fidelity perseverance, the system automatically analyzes and quantifies the differences in page fidelity between a printed document (e.g., a PDF file) and its markup language transformation (e.g., HTML5 web pages). Document pages that fail the page fidelity tests are flagged and examined. This publishing system is a part of an overall content distribution platform, an example of which is illustrated in FIG. 1. The content distribution platform not only facilitates aggregation, management, and distribution of digital education content, but also provides an integrated solution for digital publishing and online education services. As part of the content distribution platform, advertising can be presented to users in conveniently placed regions within the digital education content. In addition, the advertisement content may be correlated to a user's current and future interests as inferred from reading materials and other education events inferred from course materials as provided in specification below.

### Platform Overview

FIG. 1 illustrates a block diagram of a system environment for a digital content delivery and online education services in accordance with an embodiment of the invention. The system environment facilitates flexible distributions of digital books from publishers to end users. The content distribution platform 102 is described in more detail in patent application U.S. Ser. No. 13/253,011 titled “Electronic Content Management and Delivery Platform” filed on 4 Oct. 2011, the disclosure of which is incorporated herein by reference in its entirety.

As shown in FIG. 1, the digital reading environment comprises a content source 101, a content distribution platform 102, a network 103, and one or more clients 104. The content source 101 includes digital and printed content automatically gathered and aggregated from a large number of publishers, categories, and partners. Examples of content include textbooks, trade books, magazines, newspapers, user-generated content, web content, and advertising content.

The content distribution platform 102 aggregates, validates, transforms, packages, and monetizes the content collected by the content source 101 into a number of business services, prior to distribution to the clients 104 over the network 103. The platform comprises five systems: an ingestion system 120, a publishing system 130, a distribution system 140, a back-office system 150, and an eCommerce system 160.

The ingestion system 120 first gathers information on the type, file formats, and file manifest of the content. The ingestion system then checks files' integrity and conformity to standards, such as PDF, ePUB2, ePUB3, XML, HTML, and other formats. Content files that fail the integrity and conformity checks are flagged for further testing and repairing. Each content file that passes the checks is assigned a unique identifier and stored in a database for access by the publishing system 130.

The publishing system 130 converts ingested documents into markup language documents, for example, an HTML5 web page with enhanced metadata, which is well-suited to distribution across a wide variety of computing devices connected to the content distribution platform 102 via the network 103. Due to the original format of the source content and the complexity of the layout of the original document, the converted markup language documents are tested by the publishing system 130 to determine whether the conversion preserves the page fidelity compared to the original printed document. The page fidelity includes the original page structure, such as the pagination of the original printed document, the number of columns and arrangement of paragraphs, the placement and appearance of graphics, titles and captions, and the fonts used. Only converted documents that meet a minimum requirement of page fidelity are approved for distribution.

The distribution system 140 packages the content for delivery and uploads the content to content distribution networks. Then, the distribution system 140 makes the content available to end-users based on the content's digital rights management policies.

The back-office system 150 handles tasks dedicated to running business within the content distribution platform, such as accounting, human resource, and project management. The back-office system 150 also manages the interactions with customers, clients, and sales.

The eCommerce system 160 manages the online processes of marketing, selling, servicing and receiving payments for digital products and services. Hence the eCommerce system 160 is closely interfaced to the publishing system 130, distribution system 140, as well as the back-office system 150.

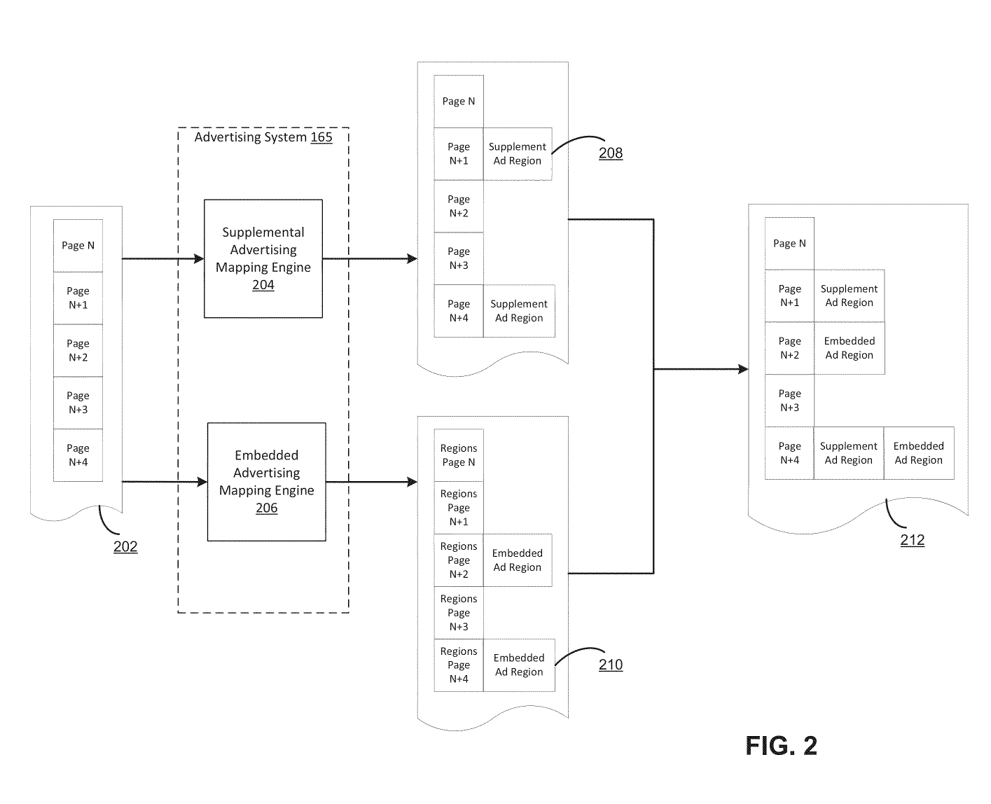

The advertising system 165 maps one or more advertisements to ad regions of a document provided by the education digital reading platform to be displayed on one or more client devices 104. In one embodiment, the advertising system 165 identifies ad regions associated with a document wherein advertisements may be displayed. Additionally, the advertising system 165 receives opportunistic data and predictive data of a user and selects one or more advertisements based on the received information. The selected advertisements are provided to a user's advertising manifest wherein the advertisements are mapped to one or more ad regions. The advertisements and its mapping to an ad region are sent to a client device 104 over a network 103. The client devices 104 reconstruct a document with advertisements displayed in appropriate ad regions as provided by the mapping. The advertising system 165 is described in greater detail in reference to FIG. 2.

The network 103 facilitates content and service distribution and communications between various components of the system environment. Contents are packaged and distributed across the network 103 for client consumption. The overall quality of service received by the clients is also monitored and reported back to the content distribution platform 102 over the network 103. The network 103 is typically a content delivery network (CDN) built on the Internet, but may include any network, including but not limited to a LAN, a MAN, a WAN, a mobile wired or wireless network, a private network, or a virtual private network.

The clients (104A and 104B, collectively 104) access the content from web browsers on computing devices connected to the network 103. The computing devices include a personal computer, such as a desktop, laptop, or tablet computer, a personal digital assistant, a mobile or smart phone, or a television “set-top box” using a client web application. The educational content are transformed by the content distribution platform 102 and delivered to the clients 104 across the network 103. As the clients enjoy the consistent reading experiences and high-quality services, the web browsers on the clients' devices regularly communicate with the content distribution platform 102 for updating reading content and connected services. In addition, user data on the clients' experience with the service and quality of the network connections are also collected and uploaded to the content distribution platform 102 through network 103.

In contrast to existing digital publishing services, such as AMAZON KINDLE®, the disclosed content distribution platform does not require users to purchase a specific client device or download a specific standalone application from the service provider to access the content. Rather, any HTML5 compatible browser on a user's computing device may receive, from the content distribution platform 102, structureless HTML5 page elements to construct pages of a document on the browser, along with a host of document specific metadata to enhance the user's reading experience with the document, such as thumbnail navigation and an interactive table of contents. The HTML5 pages of the document also supports a number of reading activities, such as creating highlights, taking notes, and accessing a dictionary. Annotations, such as highlights, drawings, notes, comments, and other personalized data created by the user can be displayed as an overlay on the original content, stored and archived in the user account, synchronized across all registered devices of the user, and optionally shared among the user's friends, classmates, campus, or other groups, as part of an education social platform. It is noted that although embodiments of the invention are described herein with reference to HTML5, other markup languages with suitable characteristics may also be used in place of HTML5.

### Identifying Ad Regions

FIG. 2 illustrates a block diagram for a system for identifying ad regions in a document to display advertisements therein. The system includes a document 202 comprising pages therein, an advertising system 165 including a supplemental advertising mapping engine 204 and an embedded advertising mapping engine 206. The supplemental advertising mapping engine 204 identifies supplemental ad regions in a document 208 and the embedded advertising mapping engine 206 identifies embedded ad regions of a document 210. The advertising system 165 therefore identifies supplement ad regions and embedded ad regions of a document 212 wherein advertisements may be displayed to a user.

The document 202 includes any document ingested by the education digital reading platform as described in the specification. The document 202 may also be referred to as a course material throughout the specification herein and in the figures. The document 202 may include for example, textbooks, syllabi, research reports, quizzes/exams or any information that is displayed by the education digital reading platform on a client device 104. The document 202 may include at least one page. In one embodiment, the pages of a document 202 are identified during ingestion and deconstruction process wherein a document 202 such as a textbook is transformed to a digital medium.

In one embodiment, the advertising system 165 comprises a supplemental advertising mapping engine 204. The supplemental advertising mapping engine 204 identifies supplement ad regions 208 associated with pages of a document 202. Supplemental ad regions 208 are areas wherein advertisements or offers may be displayed to the user. In one embodiment, the supplemental ad regions are not part of a page of a document 202. In one embodiment, the supplemental ad regions may include areas that are displayed to the user, such as above, below, or around a page of a document 202. In one embodiment, the supplement ad region 208 may include any region around a page wherein an advertisement may be displayed when a user is viewing the page on a client device 104. In yet another embodiment, the supplement ad region may support pop-up advertisements or advertisements with a moving user interface.

In one embodiment, the advertising system 165 comprises an embedded advertising mapping engine 206. The embedded advertising mapping engine 206 identifies embedded ad regions 210 wherein advertisements may be displayed. Embedded ad regions include regions or spaces within a page of a document 202 wherein an advertisement may be displayed. The embedded ad regions 210 may include for example, white spaces, blank spaces or empty spaces of a page wherein no image or a text appears. In one embodiment, the embedded advertising mapping engine 206 identifies a size of the embedded ad region 210 to enable selection of an advertisement to be placed in the embedded ad region 210.

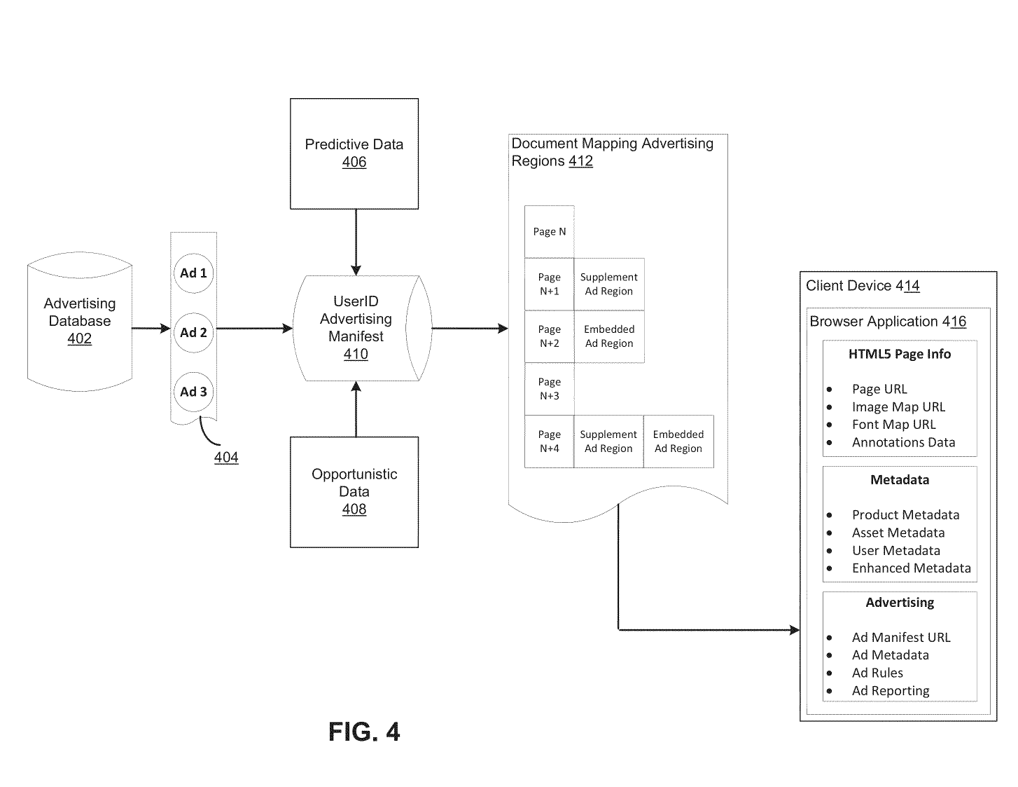

In one embodiment the advertising system 165 identifies supplemental ad regions and supplemental ad regions in a document 212. The advertising system 165 performs an inventory of the embedded ad regions and supplement ad regions wherein advertisements may be placed. The placement of advertisements in the inventory of ad regions is described in greater detail below in reference to FIG. 4.

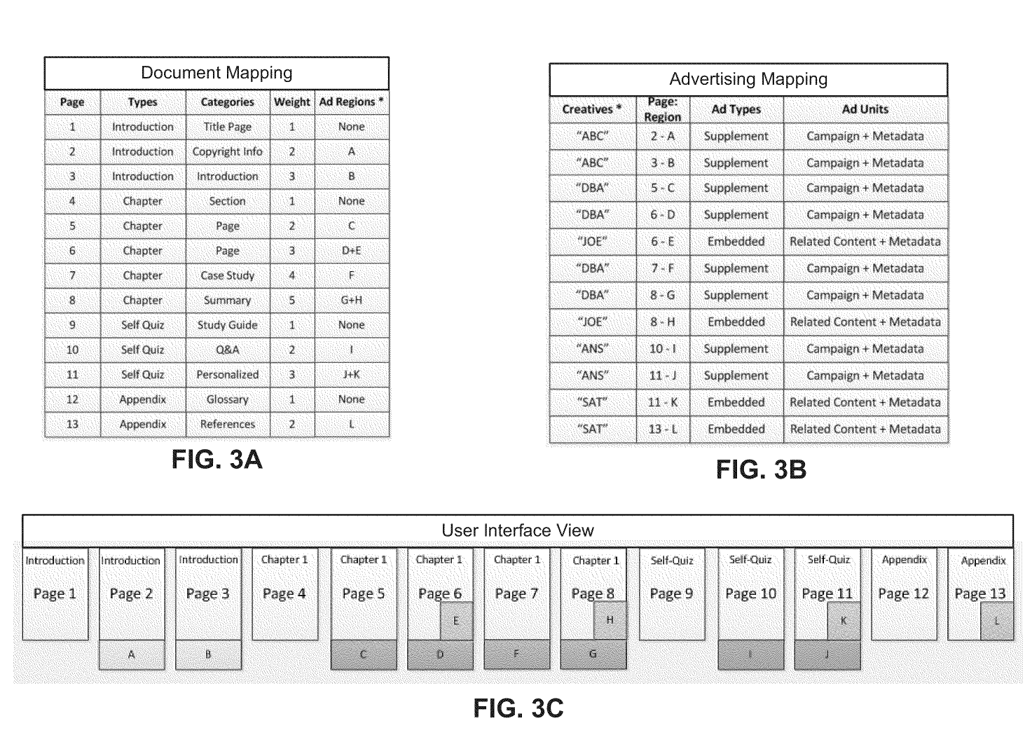

FIG. 3A is an exemplary illustration of identifying ad regions within a document to be displayed by an education digital reading platform in accordance with an embodiment of the invention. Referring now to FIG. 3A, it includes a table of pages represented in one or more rows. Additional information about each page is represented in columns associated with each row. The page information includes, but is not limited to, a type of page, a category of page, a weight of the page and ad regions associated with or within the page. For example, page one, as illustrated in FIG. 3A is an instruction page type, falls within a ‘title page’ category and has a weight of one. It also includes an identifier of the ad regions associated with the page. For example, page one as represented in FIG. 3A does not include any ad regions. Page two on the other hand includes an ad region identifier ‘A.’

Referring now to FIG. 4, it illustrates a block diagram of a system for providing advertisements within a document displayed by an education digital reading platform in accordance with an embodiment of the invention. In one embodiment, an advertising database 402 includes an inventory of advertisement creatives (also referred to as “advertisements” or “ads”) 404 that can be displayed in an ad region of a document. The advertisement creatives 404 may include offers for real goods, virtual goods, services, as well as offers for discounts on a purchase of a good or service. In one embodiment, the advertising system 165 selects advertisements that a user may be interested in viewing based on the user's predicative data 406 and opportunistic data 408.

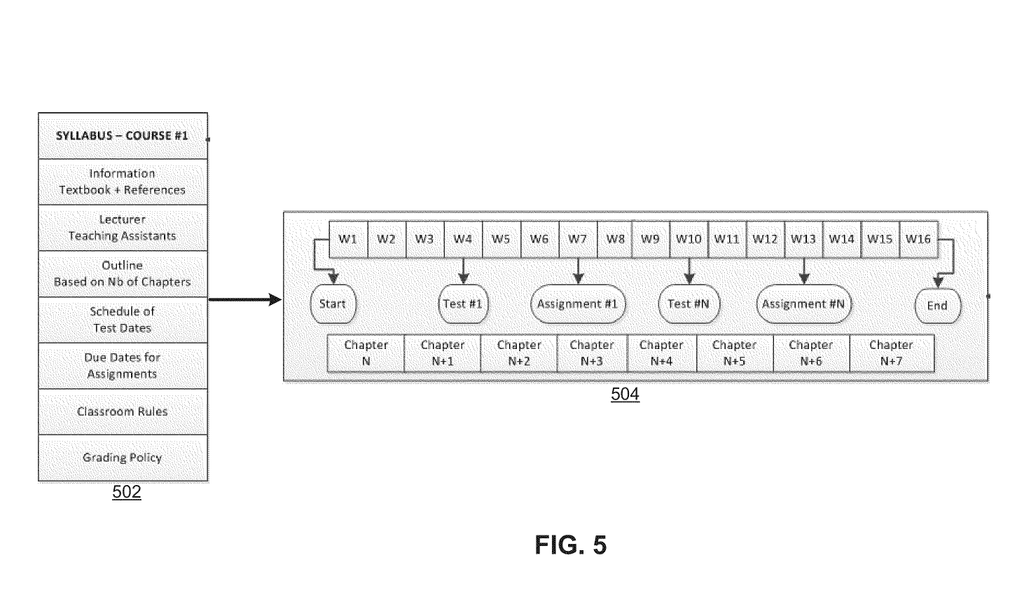

An example of a user's predictive data 406 is provided in FIG. 5. Predictive data is any information that helps identify a user's activity or location at a time in the future. A syllabus is an example of a document that provides predictive data. A syllabus is a document that is typically used as an agenda for a course and includes education events, such as a due date for a project or an assignment, a test date, etc. Other documents, such as calendars and task lists with dates and assignments may also be used in other embodiments. For example, if a syllabus provides that a user must read a page of a book by a date and a time, the advertising system 165 identifies the date as an education event and may predict that the user will be reading the relevant page at a time before the deadline. Similarly, if a syllabus provides that a user must be present in class or at a lab at a particular time, the advertising system identifies such an entry as an education event and may use the information to predict that the user will likely be at a location at the give time in the future.

Referring now to FIG. 5 it illustrates a course syllabus ingested by an education digital reading platform in order to identify predictive information about a user, accordance with an embodiment of the invention. A syllabus 502 may include a variety of information, including but not limited to information about textbooks and references, lecturers, teaching assistants, an outline of chapters or pages covered in the course, a schedule of test dates, due dates for assignments, classroom rules, grading policy, etc. In one embodiment, the education digital reading platform deconstructs the syllabus 502 to identify tasks or assignments associated with each date provided in a syllabus (in this example weeks 1-16). For example, the education digital reading platform generates a listing 304 associating a date, or a week, with a test or an assignment as well as an assigned chapter for reading. In other embodiments, other information may be compiled by the education digital reading platform based on the information provided by a syllabus 502.

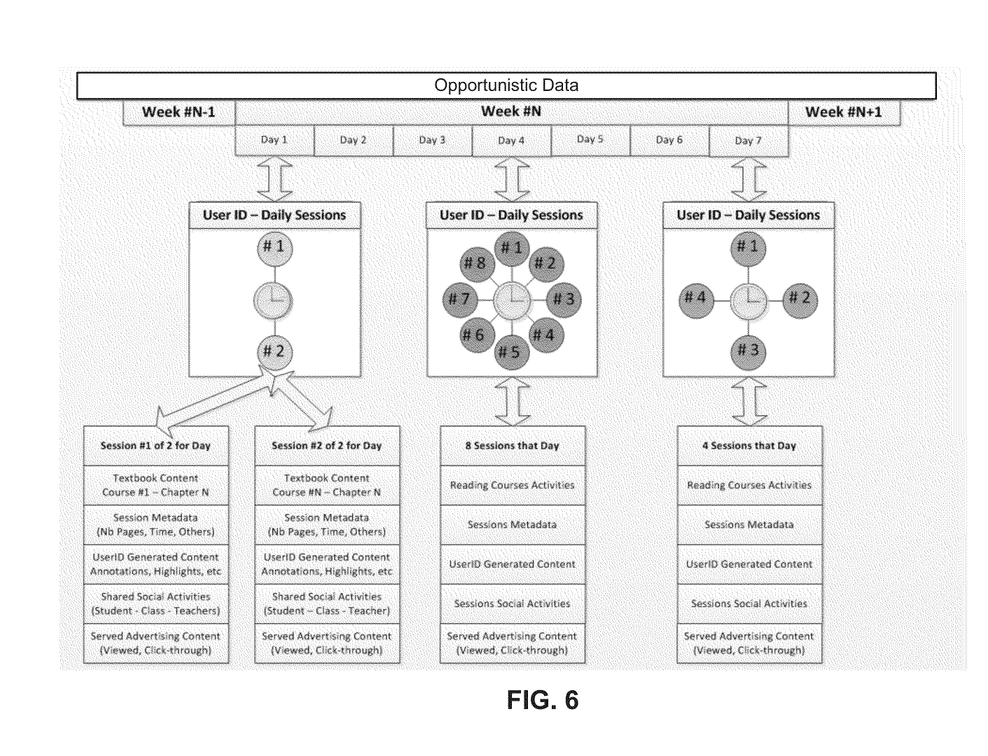

An example of a user's opportunistic data 408 is provided in FIG. 6. Opportunistic data is any data that helps identify a user's current activity, location, interest, etc. For example, if a student logs-into the education digital reading platform service and begins reading a page of a book, the advertising system 165 may identify the user's interest based on the content of the page being read by the user. Similarly, the advertising system 165 may identify the user's location based on where the user logs-in from. The advertising system 165 may also identify a log-in location of several users who are connected to each other in a digital social network within the education digital reading platform. If the users are enrolled in a same course and are logged-in from approximately the same location, the advertising system 165 may predict that the students are engaged in group based activity or a study session. In such an instance, the advertising system may serve advertisements that the group may be interested in purchasing or viewing.

Referring now to FIG. 6, it illustrates opportunistic data gathered by an education digital reading platform in accordance with an embodiment of the invention. In one embodiment, the education digital reading platform tracks each action performed by the user. For example, on day one, as illustrated in FIG. 6, when a user logs onto the education digital reading platform, the user's identifier is registered and a session is created, wherein a session is a grouping of activities performed by a user within a period of time. A session may include, for example, textbook content displayed to a user, session metadata such as time the pages are viewed, number of pages viewed, etc., user generated data such as annotations, highlights, etc., social activities between students, classmates and teacher, and advertised content. In one embodiment, the education digital reading platform may receive such information about a user if the user's privacy settings provides appropriate permissions to the education digital reading platform. In one embodiment, the advertising system 165 identifies opportunistic data about a user in substantially real time as a user logs-in or interacts with items in the education digital reading platform.

Referring again to FIG. 4, the predictive data 406 and the opportunistic data 408 is provided to a userID advertising manifest 410 wherein advertisement creatives 404 are selected to display to the user based on the user data. In one embodiment, the userID advertising manifests 410 receives advertisement creatives 404 and selects advertisements that a user may be interested in viewing based on the user's predictive data 406 and opportunistic data 408. For example, a user who is predicted to read a chapter on performing a chemistry experiment may be interested in purchasing merchandising that enables students to perform experiments, such as, for example, lab equipment. Similarly, a user who is logged into the education digital reading platform from a library at a night before the exam, may be interested in purchasing food or interested in a coupon that offers a discount on food that can be delivered at the library. As such, the userID advertising manifest 410 selects advertisements that the user may be interested in based on the user's predictive 406 and opportunistic 408 data and associates the selected advertisements with a userID.

In one embodiment, the userID advertising manifest 410 maps advertisements to one or more ad spaces in a document 412. For example, the userID advertising manifest maps advertisements to supplement ad regions or embedded ad region. An example of mapping advertisement creatives to ad regions is illustrated in FIG. 3B, in accordance with an embodiment.

Referring now to FIG. 3B, it illustrates a chart wherein each advertisement creative is mapped to an ad region identified by the advertising system 165. An advertisement creative, such as ‘ABC’ may be mapped to page two, region A as identified and illustrated in FIG. 3A. The chart may also include a description of the ad type, whether it is a supplemental ad region or an embedded ad region and a description of the advertisement unit, including whether the advertisement unit is part of a campaign, is associated with related content displayed on a page displaying the advertisement and metadata associated with the ad.

In one embodiment, advertisement creatives are mapped to an ad region if an advertiser provides such instructions. In such an instance, there may be no correlation between the advertisement creatives and the pages wherein they are displayed. In one embodiment, advertisements for business that are local or near a user may be preferentially displayed on a document page over advertisements for items or businesses that are not local. A user's location may be identified from information provided by the user or based on the user's log-in history. In another embodiment, the education digital reading platform promotes particular advertisements over others. For example, the advertisements that are directly or indirectly correlated to content of a page being displayed to the user, may be preferentially displayed to the user over uncorrelated advertisements. In yet another embodiments, an advertisement that is directly or indirectly correlated to metadata of a content page may be preferentially selected to display in an ad space. For example, if a page's metadata provides that a textbook is a geography textbook and that an image on a page is a map, advertisements that are related to travel services, mapping software, etc., may be preferentially be selected to display to a user in an ad space. Referring again to FIG. 4, the advertisement creatives that are mapped to an ad region are sent to a client device over a network, as described in the specification. In one embodiment, the advertisement creatives and the document mapping advertising regions 412 are sent as HTML 5 page information to a client device 414 executing a browser application 416, wherein the browser application requesting the HTML 5 page information responsive to a user instruction. HTML 5 page information may include for example, a page uniform resource locator (URL), an image map of the page URL, a font map of the page URL, user generated data, etc. In addition, metadata associated with a page may also be sent to the client device 414 executing a browser application 416 including for example, a web browser. The advertisements selected and sent to be displayed within the one or more ad regions of a document 412 may include, for example, an ad manifest URL, metadata associated with the ad, rules associated with the ad, including, for example, how to display an ad and ad reporting data allowing an advertiser to measure the displayed advertisement's metrics, such as click through rates, ad displays, etc.

FIG. 3C provides a graphical illustration of advertisements displayed in one or more ad regions of pages of a document, in accordance with an embodiment of the invention. The user interface view, for example, may include a page one without any advertisements. Page two however, may include a supplement ad region as illustrated in FIG. 3A and the ad region may display an ad ‘ABC’ as illustrated in FIG. 3B. As such, advertisements may be displayed to a user within supplement ad regions and embedded ad regions of a page or a document. In one embodiment, an advertisement may be displayed to the user several times in one or more sessions. For example, an ad creative ‘ABC’ may be displayed in an ad region on pages two and three.

Embodiments described herein provide a method for allowing users advertisers to display one or more ads to users of an education digital reading platform. Additionally, the education digital reading platform is enabled to effectively identify ad regions within a page of a document that may be appropriate for an advertisement and wherein the ad regions minimally impact an education or a reading experience. In addition, the education digital reading platform is enabled to provide advertisements that a user is likely interested in, based on course materials and education events identified from the course materials and provide advertisements to users that an advertiser is interested in reaching out to. As such, the education digital reading platform may limit advertisements that may not be of interest to a user and/or wherein an advertiser wants to reach out to users meeting a particular criteria.

### Additional Configuration Considerations

The present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not limited to any particular programming language. It is appreciated that a variety of programming languages may be used to implement the teachings of the present invention as described herein, and any references to specific languages, such as HTML5, are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method of electronic content management and delivery, the method comprising:
receiving a syllabus, the syllabus including at least one education event and at least one course material;
identifying available ad regions in the at least one course material;
selecting an advertisement creative for placement in the ad region based on user data;
adding the selected advertisement creative to a user identification manifest for placement in the course material.

2. The method of claim 1, wherein the available ad regions comprise supplement ad regions surrounding a page of the course material.

3. The method of claim 1, wherein the available ad regions comprise embedded ad regions within a page of the course material.

4. The method of claim 1, wherein the available ad regions are identified by available blank space on a page of the course material.

5. The method of claim 1, wherein the user data includes predictive data suggesting a user activity at a particular time, the predictive data identified from the syllabus.

6. The method of claim 1, wherein the user data includes opportunistic data describing user activity on the education platform.

7. The method of claim 6, wherein the opportunistic data of a user being correlated with opportunistic data of other users, the correlation providing opportunistic data for a group of users connected to each other within an education digital reading platform.

8. The method of claim 1, wherein the advertisement creative selected for placement in an ad region based on at least one of predictive data and opportunistic data associated with a user.

9. The method of claim 1, further comprising:
mapping the selected advertisement creative with at least one ad region in the course material; and
providing the advertisement creative to the user for display on a user device.

10. A computer-readable storage medium storing executable computer program instructions for electronic content management and delivery, the computer program instructions comprising instructions for:
receiving a syllabus, the syllabus including at least one education event and at least one course material;
identifying available ad regions in the at least one course material;
selecting an advertisement creative for placement in the ad region based on user data;
adding the selected advertisement creative to a user identification manifest for placement in the course material.

11. The computer-readable medium of claim 12, wherein the available ad regions comprise supplement ad regions surrounding a page of the course material.

12. The computer-readable medium of claim 12, wherein, the available ad regions comprise embedded ad regions within a page of the course material.

13. The computer-readable medium of claim 12, wherein the available ad regions are identified by available blank space on a page of the course material.

14. The computer-readable medium of claim 12, wherein the user data includes predictive data suggesting a user activity at a particular time, the predictive data identified from the syllabus.

15. The computer-readable medium of claim 12, wherein the user data includes opportunistic data describing user activity on the education platform.

16. The computer-readable medium of claim 12, wherein the opportunistic data of a user being correlated with opportunistic data of other users, the correlation providing opportunistic data for a group of users connected to each other within an education digital reading platform.

17. The computer-readable medium of claim 12, wherein the advertisement creative selected for placement in an ad region based on at least one of predictive data and opportunistic data associated with a user.

18. The computer-readable medium of claim 12, further comprising instructions for:
mapping the selected advertisement creative with at least one ad region in the course material; and
providing the advertisement creative to the user for display on a user device.
